(19) United States
(12) Patent Application Publication
(10) Pub. No.: US 2004/0133624 A1
(43) Pub. Date: Jul. 8, 2004

(54) Method and apparatus for performing common call processing management using common software platform

(76) Inventor: Seung-Joon Park, Suwon-shi (KR)

Correspondence Address: Robert E. Bushnell, Suite 300, 1522 K Street, N.W., Washington, DC, 20005-1202, US

(21) Appl. No.: 10/714,843

(22) Filed: Nov. 18, 2003

(30) Foreign Application Priority Data
Jan. 6, 2003 (KR) 2003-587

(51) Int. Cl. G06F 15/16

(52) U.S. Cl. 709/200; 719/317

(57) ABSTRACT

A method for performing common call processing management using a common software platform including horizontal components for providing common functions required in all communication systems, and vertical components for providing specific functions on the basis of communication systems, including: allowing a common agent to perform corresponding operations including an operation of gathering Internet information on the basis of a predetermined schedule irrespective of a manager's intervention; allowing an OAM (Operations Administration and Maintenance) module to administer and maintain a network in which the corresponding operations are performed on the Internet; and allowing a common call processor to manage a subscriber in response to a call signal provided from a physical component receiving a subscriber signal and set up a voice path on the basis of the call signal such that the subscriber signal can be transmitted through the voice path.

### CLAIM OF PRIORITY

This application makes reference to, incorporates the same herein, and claims all benefits accruing under 35 U.S.C. § 119 from an application for METHOD AND APPARATUS FOR PERFORMING COMMON CALL PROCESSING MANAGEMENT USING COMMON SOFTWARE PLATFORM earlier filed in the Korean Industrial Property Office on 6 Jan. 2003 and there duly assigned Serial No. 2003-587.

### BACKGROUND OF THE INVENTION

1. Field of the Invention

The present invention relates to a method for performing CPM (Call Processing Management) in a voice service system, and more particularly to a method for performing CCPM (Common Call Processing Management) capable of reducing a functional dependency on a switching signal processing interface protocol and a subscriber line interface protocol.

2. Description of the Related Art

Through a conventional call processing method, call processing management and voice path connection management based on a switching signal processing interface protocol and a subscriber line interface protocol are provided by different software modules on the basis of a service type. In particular, the call processing management has a structure dependent upon the switching signal processing interface protocol. As a result, according to the conventional call processing method, relevant call processing modules must be newly added or reconfigured in a communication system every time a new switching signal processing interface or a new subscriber line interface is newly added to the communication system. Where the relevant call processing modules are added or reconfigured in the communication system, there is a problem in that the communication system must be newly tested to ensure the stability of a system operation.

It will be understood that a module for performing a call processing function in the conventional communication system operates while depending upon the switching signal processing interface protocol and the subscriber line interface protocol. As a result, where the new switching signal processing interface or the new subscriber line interface is applied to the communication system, a repeated overload in the system can be caused by the addition or reconfiguration of the call processing modules based on the switching signal interface protocol and the subscriber line interface protocol. Moreover, a period of time and costs required to develop the communication system can be increased. There is another problem in that reusability and portability of the pre-existing call processing software are degraded.

### SUMMARY OF THE INVENTION

Therefore, the present invention has been made in view of the above problems, and it is an object of the present invention to provide a method for flexibly performing integrated call processing without depending upon a switching signal processing interface protocol and a subscriber line interface protocol adopted in a communication system.

It is another object of the present invention to provide a method for flexibly performing integrated call processing, without depending upon a switching signal processing interface protocol and a subscriber line interface protocol adopted in a communication system, by implementing common software architecture and reusable software appropriate for easily developing various media gateway systems.

In accordance with an aspect of the present invention, the above and other objects can be accomplished by the provision of an apparatus for performing common call processing management using a common software platform including horizontal components for providing common functions required in all communication systems, and vertical components for providing specific functions on the basis of communication systems, including: a common agent for performing corresponding operations including an operation of gathering Internet information on the basis of a predetermined schedule irrespective of a manager's intervention; an OAM (Operations Administration and Maintenance) module for administering and maintaining a network in which the corresponding operations are performed on the Internet; and a common call processor for managing a subscriber in response to a call signal provided from a physical component receiving a subscriber signal and setting up a voice path on the basis of the call signal such that the subscriber signal can be transmitted through the voice path.

Preferably, the common call processor may include a CPM API (Call Processing Management Application Program Interface) for providing a switching interface, subscriber interfaces and an interface between call processing modules; an event decoding module for decoding a corresponding command and extracting physical termination information and a relation index; a component specific call processing module for organizing components for performing corresponding functions based on the switching interface and the subscriber interfaces and interfacing with a lower-order module; a common call signal management module for processing and routing a signal generated from the switching interface and a control signal to a corresponding module in response to a request from a subscriber interface; a common connection management module for controlling a connection for setting up a voice path irrespective of hardware and an application program; and a call resource management module for managing system resources associated with call processing.

Preferably, the component specific call processing module may include a vertical component having at least one of an MGCP (Media Gateway Control Protocol) interface, a V5.2 interface and a GR303 interface being voice call signal interfaces. Preferably, the physical component may include at least one of a switch module, a tone generator and a physical port.

Preferably, the common call processor may perform specific call processing according to kinds of vertical and physical components on the basis of the extracted physical termination information and relation index, allocate a system's switching resources, decide path information and generate a control command for a physical switch. Preferably, the path information decided by the common call processor may include address information associated with at least one of a card location and a destination by switching.

The present invention provides horizontal components, which provide common functions and hence can be reused in various communication systems, thereby enabling a software module to be configured without depending upon an OS (Operating System) or hardware device, when a communication system is implemented. Further, the present invention provides a CPM API capable of minimizing an additional workload according to program change at the time of call processing by hiding specific information associated with lower-order software and hardware according to respective interface modules. Furthermore, the present invention provides a CCPM module capable of hiding a logical relation between the vertical components processing switch signals such as an MGCP interface, a V5.2 interface and a GR303 interface, and physical components such as PSTN and VoDSL ports, and physical configurations of the communication system such as switch configurations, and organizing common and individual modules on the basis of call processing functions, thereby easily developing and verifying new voice service functions and reducing a period of time required to develop and stabilize the functions.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a common software platform for common call processing in accordance with the present invention;

FIG. 2 is a view illustrating the connection relationship between vertical components included in a CCPM (Common Call Processing Management) module shown in FIG. 1;

FIG. 3 is a view illustrating detailed configurations of the CCPM module in which vertical components are embedded as shown in FIG. 1; and

FIG. 4 is a view illustrating operations between a master and slaves according to event processing between V5.2 and GR303 interfaces of the CCPM module and a VoDSL (Voice over DSL (Digital Subscriber Line)) interface subscriber.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description given in conjunction with preferred embodiments of the present invention, a variety of specific elements are shown. The description of such elements has been given only for a better understanding of the present invention. Those skilled in the art will appreciate that the present invention can be implemented without using the above-mentioned specific elements. Also, in the following description, a detailed description of known functions and configurations incorporated herein will be omitted when it may make the subject matter of the present invention rather unclear.

Further, the following references provide the description of the related art and additional information, so that the present invention can be better understood through the following references.

Open Systems Interconnection, Basic Reference Model, ITU-T X.200 (telecommunication standardization sector of the International Telecommunication Union X-series recommendations on open systems interconnection)

Open Systems Interconnection, Data Link Service Definition, ITU-T X.212

Open Systems Interconnection, Network Service Definition, ITU-T X.213

Open Systems Interconnection, Transport Service Definition, ITU-T X.214

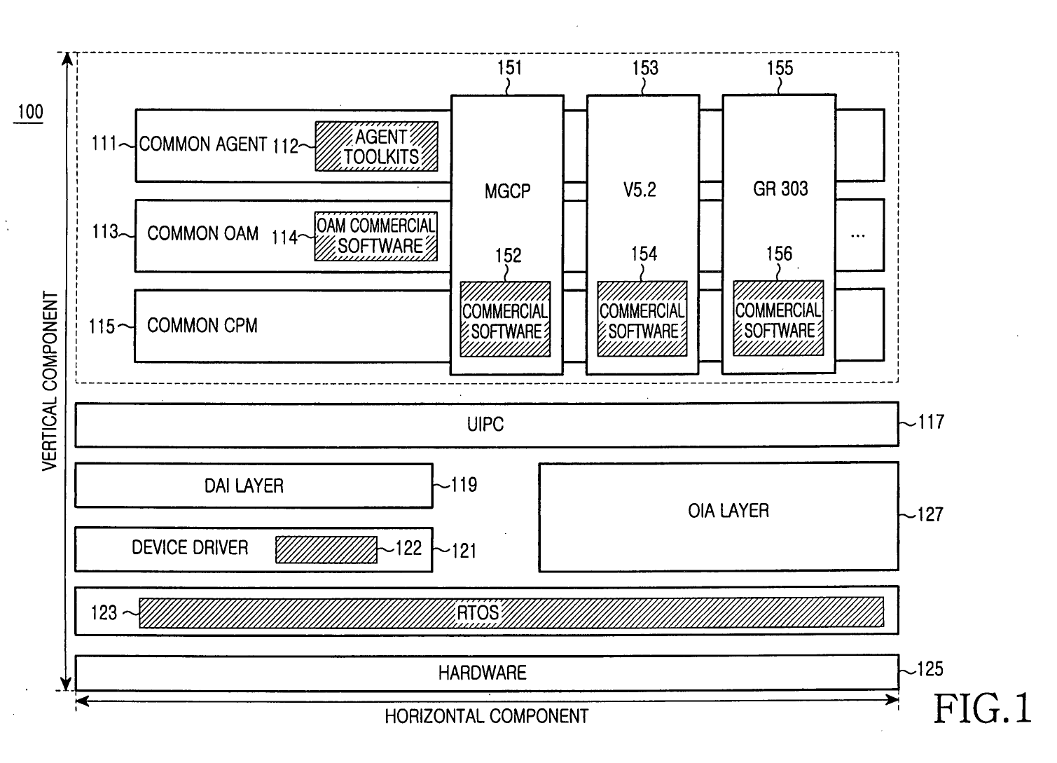

FIG. 1 is a block diagram illustrating a common software platform for common call processing in accordance with the present invention.

As shown in FIG. 1, a common software platform 100 can be commonly applied to a plurality of different communication systems. The common software platform 100 is arranged within a communication network card and includes components classified on the basis of functions.

The common software platform 100 includes horizontally arranged horizontal components and vertically arranged vertical components. The horizontal components provide common functions required in all communication systems. The vertical components provide particular technical functions, which may be required in the communication systems. The vertical components provide the horizontal components with the technical functions and can vary with the communication system.

As shown in FIG. 1, the horizontal components having the common functions required in all communication systems include a common agent 111, a common OAM (Operations Administration and Maintenance) module 113, a CCPM (Common Call Processing Management) module 115, a UIPC (Unified InterProcess Communication) module 117, a DIA (Device Independent Access) layer 119, a device driver 121, an OIA (Operating System Independent Access) layer 127, an RTOS (Real Time Operating System) 123 and hardware 125. Here, the “agent” is a software module for gathering Internet information according to a predetermined schedule without a manager's intervention or performing several different services. Further, the “OAM” module is a software module for providing network management functions such as network fault indication, performance information indication and data diagnosis.

Further, the vertical components having the technical functions required by the communication systems include an MGCP (Media Gateway Control Protocol) interface 151, a V5.2 interface 153 and a GR303 interface 155. Commercial softwares are used or added in hatched blocks 112, 114, 152, 154, 156, 122 and 123 shown in FIG. 1.

Various types of components other than the components shown in FIG. 1 can be configured as vertical or horizontal components. For example, the common OAM module 113 being the horizontal component gathers and manages alarm and performance data to perform the administration and maintenance of a communication system. An ATM (Asynchronous Transfer Mode)-based communication system adds ATM related alarm and performance data to an ATM vertical component, thereby providing a relevant service.

Thus, the communication system implements the horizontal components, which provide the common functions and hence can be reused in various communication systems, thereby enabling a software module to be configured without depending upon an OS (Operating System) or hardware device.

In accordance with this embodiment of the present invention, the CCPM module 115 can implement a common call processing function.

When the vertical components such as call processing interfaces of the MGCP interface 151, the V5.2 interface 153 and the GR303 interface 155 are mounted in the communication system, the CCPM module 115 provides the following functions between the vertical components and physical components associated with physical voice subscriber lines.

First, the CCPM module 115 provides a subscriber registration function for setting up and maintaining a logical relation between physical voice subscriber ports and logical entities belonging to the respective vertical components in response to system commands.

The CCPM module 115 provides a subscriber registration release function for releasing a pre-set logical relation between physical voice subscriber ports and logical entities belonging to the respective vertical components 151, 153 and 155 in response to system commands.

The CCPM module 115 manages a provisional status and an operational status associated with the physical voice subscriber ports and the logical entities belonging to the respective vertical components 151, 153 and 155, and provides a subscriber-status management function such as a function of transferring status information to entity management modules.

The CCPM module 115 routes subscriber signals such as an off-hook signal, an on-hook 11 signal, etc. received from the physical voice subscriber lines to a corresponding vertical component on the basis of a subscriber protocol, thereby providing a function of transferring a subscriber call signal to a switch (not shown).

The CCPM module 115 receives, from a vertical component, a subscriber line control signal transmitted from the switch receiving the subscriber call signal and then performs a function of routing the subscriber line control signal to a corresponding subscriber management module.

The CCPM module 11 analyzes a voice path connection setup command transmitted from each vertical component, and controls operations of switch components included in a corresponding communication system on the basis of the analyzed command. Thus, the CCPM module 115 provides a function of setting up a voice path between a subscriber and a switching network.

The CCPM module 115 controls operations of the switch components included in the communication system in response to a command received from the vertical component in order to control a pre-set voice path connection. Thus, the CCPM module 115 provides a function of releasing a voice path between the subscriber and the switching network.

The CCPM module 115 provides a function of managing set voice path connection status in response to commands from the vertical components 151, 153 and 155. The CCPM module 115 provides a function of managing system resources relating to call processing. Further, the CCPM module 115 provides a common API (Application Program Interface) such that modules controlling the vertical and physical components can access the CCPM module 115.

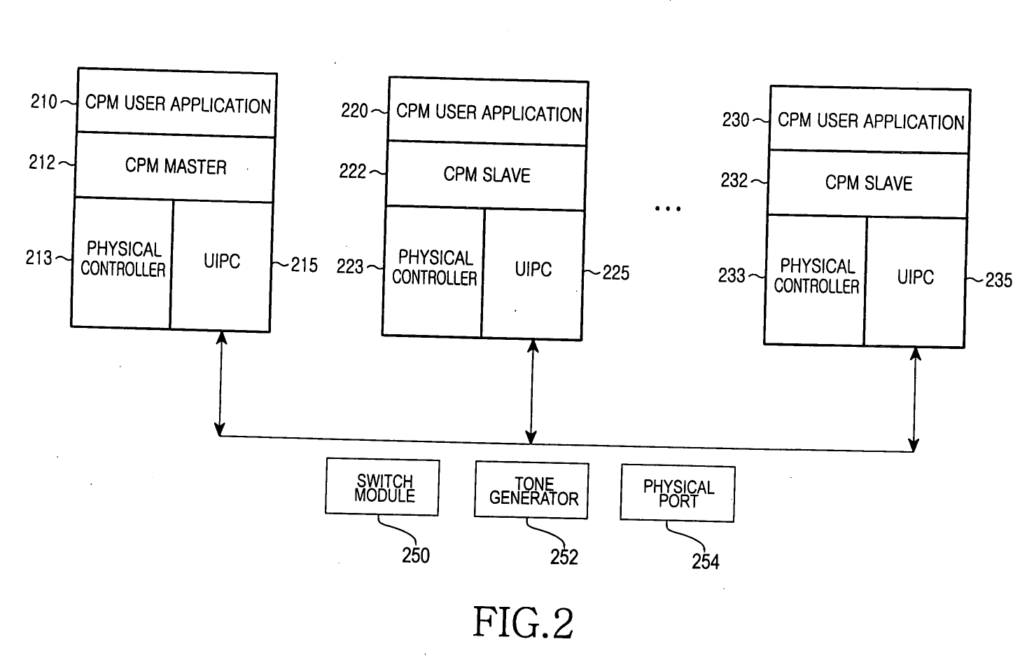

FIG. 2 is a view illustrating the connection relationship between vertical components included in the CCPM module 115 shown in FIG. 1. As shown in FIG. 1, the CCPM module 115 has a master-slave structure including a single CPM (Call Processing Management) master 212 and a plurality of CPM slaves 222 and 232.

The CPM master 212 manages resources for call processing by allocating and releasing system resources associated with the call processing and analyzes control commands received from vertical components. The CPM master 212 generates control messages for the CPM slaves 222 and 232 on the basis of the analyzed control commands and routes the generated control messages to the UIPC module 215. Moreover, the CPM master 212 generates and manages data for call processing, and routes subscriber call signals received from the physical components to corresponding vertical components using pre-set subscriber information.

Moreover, the CPM slaves 222 and 232 route call-related events received from the vertical components to the CPM master 212 or route a call-related event received from the CPM master 212 to the vertical components. The CPM slaves 222 and 232 route call-related events received from the physical components to the CPM master 212 or route a call-related event received from the CPM master 212 to the physical components. The CPM slaves 222 and 232 receive a control command from the CPM master 212 and control a physical component through a physical controller 213 in response to the received control command. At this time, physical components controlled by the CPM slaves 222 and 232 according to the control command from the CPM master 212 include, for example, a switch module 250, a tone generator 252 and a physical port 254. A CPM user application 210 corresponds to the CPM master 212, a CPM user application 220, a physical controller 223, and a UIPC module 225 correspond to the CPM slave 222, while a CPM user application 230, a physical controller 233, and a UIPC module 235 correspond to the CPM slave 232 as seen in FIG. 2.

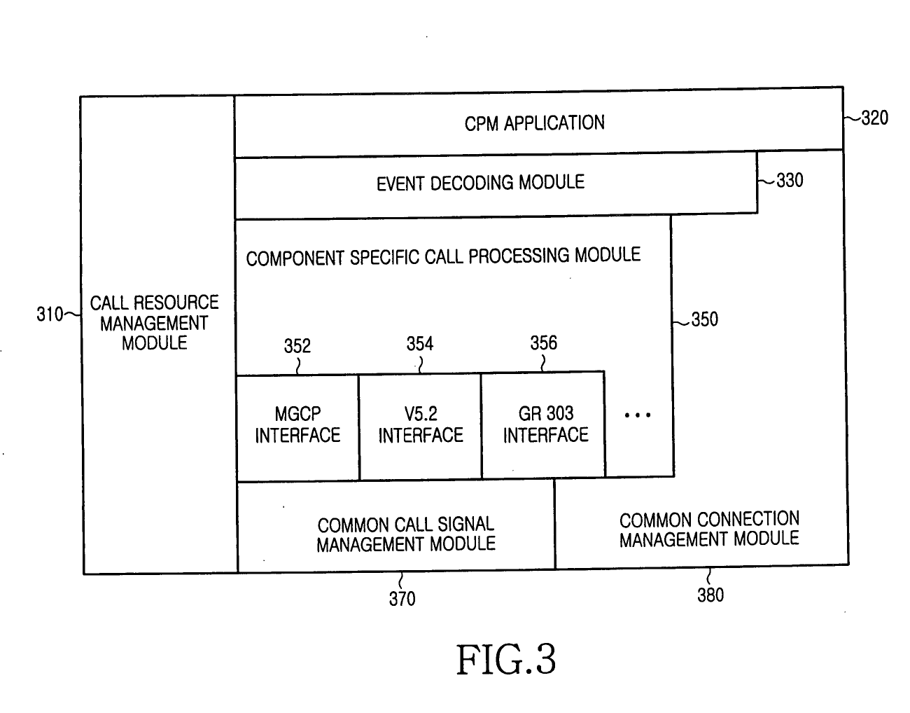

FIG. 3 is a view illustrating detailed configurations of the CCPM module in which vertical components 151, 153 and 155 are embedded as shown in FIG. 1. As shown in FIG. 3, the CCPM module 115 includes a CPM API (Call Processing Management Application Program Interface) 320, an event decoding module 330, a component specific call processing module 350, a common call signal management module 370, a common connection management module 380 and a call resource management module 310. Here, the component specific call processing module 350 includes vertical components such as an MGCP interface 352, a V5.2 interface 354, a GR303 interface 356, etc.

The CPM API 320 provides an interface between a switching signal processing interface module, a subscriber line interface module and call processing modules 352, 354 and 356. At this time, the CPM API 320 operates through an API in which interfaces of the call processing modules 352, 354 and 356 are integrated. Thus, the CPM API 320 can minimize an additional workload according to program change at the time of call processing by hiding specific information associated with lower-order software and hardware according to the respective interface modules.

The component specific call processing module 350 and the vertical components 352,354 and 356 organizes special components according to a switching signal, a type of a subscriber line interface and a configuration of a communication system, and have interfaces coupled to the common call signal management module 370 and the common connection management module 380. Thus, even though a new interface or a new function module is added in the communication system, an additional workload can be minimized.

The common call signal management module 370 processes and routes off-hook, flash-hook and on-hook signals generated from a subscriber interface irrespective of a kind of a subscriber interface or switching interface. Moreover, the common call signal management module 370 processes and routes ringing and tone signals as control signals associated with a subscriber in response to a request from the switching interface.

The common connection management module 380 performs a connection control procedure for a voice signal path connection irrespective of hardware and an application program.

The call resource management module 310 manages communication system resources relating to call processing.

The CCPM module 115 includes a subscriber management function, a voice call signal routing function and a voice path connection management function. First, the CCPM module 115 performs the subscriber management function of setting up or releasing relations between the vertical components 151, 152 and 155 and the physical components. Second, the CCPM module 115 performs the voice call signal routing function of transferring call signals between respective entities of the vertical components 151, 153 and 155 and physical entities. Third, the CCPM module 115 performs the voice path connection function of setting up or releasing voice path connections in response to control commands of the vertical components 151, 153 and 155.

The subscriber management function is activated in response to an operator command and performs the following procedure. The CCPM module 115 receives a subscriber command generated from an operator and extracts address information corresponding to an entity of a vertical component and address information corresponding to an entity of a physical component. At this time, the CCPM module 115 generates one relation using each piece of the address information. Here, the address information is different according to the vertical component and the physical component, and used on the basis of entity management regulation of a corresponding component.

Hereinafter, the functions of the CCPM module 115 will be described in detail. The CCPM module 115 allocates a single index on a system basis for each of the relations between the vertical components 151, 153 and 155 and the physical components. At this time, the allocated relation index is used as a subscriber index.

The CCPM module 115 transfers allocated relation indexes and address information to modules for managing the vertical components 151, 153 and 155 and the physical components, thereby enabling the common call signal management module 370 and the common connection management module 380 to identify that an individual entity is registered as one subscriber through a specific relation index. Thus, the CCPM module 115 can perform an appropriate call processing procedure for each entity.

Hereinafter, the following procedure associated with the voice call signal routing function will be performed, when the CCPM module 115 receives call-related signals from the entities of the vertical components 151, 153 and 155 or the physical components.

The CCPM module 115 receives the call signals from the common call signal management module 370 and the common connection management module 380 for managing the vertical components 151, 153 and 155 and the physical components through the CPM API 320. Where a CPM slave receives a call signal, the CCPM module 115 routes corresponding information to a CPM master. The CCPM module 115 decodes the received call signal and extracts, from the decoded call signal, a relation index and information of a component transmitting the call signal. The CCPM module 115 retrieves relation information from a call-processing database (not shown) using the extracted relation index.

The CCPM module 115 extracts peer component information from the relation information, decides routing information and generates a CPM message. The CCPM module 115 transfers the generated CPM message to a corresponding CPM slave on the basis of the routing information.

The CPM slave receiving the call signal from the CPM master transfers the call signal to a corresponding module using an API provided by the common call signal management module 370 and the common connection management module 380 for managing the vertical components 151, 153 and 155 and the physical components and transfers a response signal to the CPM master.

The voice path connection function is activated in response to a control command from the vertical component 151, 153 or 155, and performs the following procedure. The CCPM module 115 receives a voice path connection command from the vertical component 151, 153 or 155 through the CPM API 320. The CCPM module 115 decodes a corresponding command through the event decoding module 330 and extracts physical termination information (end-to-end information) and a relation index for the voice path connection.

The CCPM module 115 performs specific call processing according to kinds of vertical and physical components on the basis of the extracted physical termination information and relation index, allocates a system's switching resources, decides path information and generates a control command for a physical switch. At this time, the path information includes address information associated with a card location, a destination, etc.

The CCPM master 212 transfers the generated control command to a corresponding CPM slave. A CPM slave receiving a voice path connection command from the CPM master 212 calls a connection setup API of a corresponding component management module to control a physical switch device. The CPM slave controls the physical switch device and transfers a result of the control to the CPM master 212.

Moreover, the CPM master 212 receives the result of the control and calls a callback function included in the voice path connection command received from the vertical component to transfer relevant information to the vertical component 151, 153 or 155. At this time, the relevant information includes, for example, the number of transmitted/received RTP (Real-time Transport Protocol) packets, a UDP (User Datagram Protocol) address, etc.

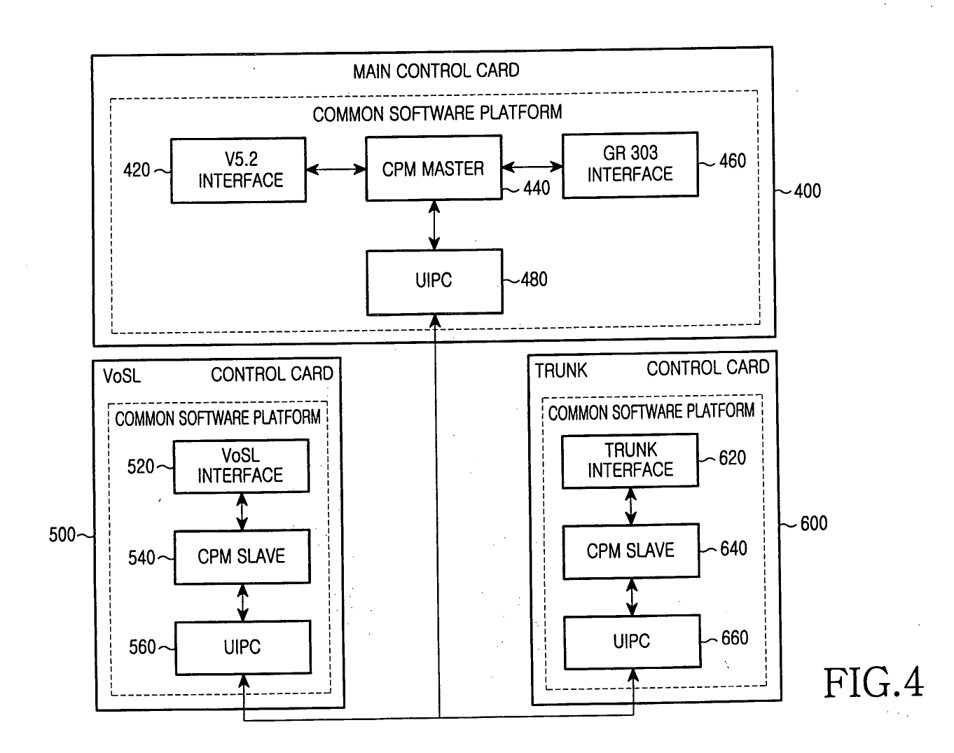

FIG. 4 is a view illustrating operations between a master and slaves according to event processing between V5.2 and GR303 interfaces of the CCPM module 115 and a VoDSL (Voice over DSL (Digital Subscriber Line)) interface subscriber. As shown in FIG. 4, one main control card 400 is connected to a plurality of slave control cards 500 and 600 controlled by the main control card 400. Further, the main control card 400 and the slave control cards 500 and 600 provide UIPC modules 480, 560 and 660 for inter-process message communications as components of a common software platform. The UIPC modules 480,560 and 660 provide paths for message communications within cards and between cards.

The UIPC modules 480, 560 and 660 are coupled to processes for performing corresponding operations. In accordance with this embodiment, the UIPC module 480 of the main control card 400 is coupled to a CPM master 440 and the UEPC module 560 of the VoDSL control card 500 is coupled to a CPM slave 540 of the VoDSL control card 500. The UIPC module 660 of the trunk control card 600 is coupled to a CPM slave 640 of the trunk control card 600.

In FIG. 4, the VoDSL control card 500 receives subscriber signals such as on-hook and off-hook signals, etc. generated from LADs (Integrated Access Devices) (not shown) coupled to xDSL interfaces through a VoDSL interface 520. The VoDSL interface 520 transfers the received subscriber signals to the CPM slave 540. The CPM slave 540 transmits the subscriber signals to the main control card 400 such that the subscriber signals can be transmitted to the UIPC module 480 of the main control card 400 through the UIPC module 560. Thus, the CPM master 440 transfers the received subscriber signals to the V5.2 interface 420 being the switching interface. Further, the CPM master 440 transfers subscriber signals received from the V5.2 interface 420 to the VoDSL control card 500 through the UIPC module 480.

In FIG. 4, the trunk control card 600 provides a physical El (European subscriber line) interface function based on V5.2 and a signal termination function based on LAPV-5. Thus, the trunk control card 600 extracts a subscriber signal and a voice path connection message transmitted from a switch and transfers the extracted subscriber signal and voice path connection message to the V5.2 interface 420 of the main control card 400. Further, the trunk control card 600 controls a connection of a subscriber voice path coupled to a trunk interface 620 in response to the voice path connection message.

The main control card 400 includes the V5.2 interface 420, a GR303 interface 460 and the CPM master 440. Thus, the CPM master 440 controls a system operation associated with a voice service in response to the received subscriber signal and a switching control signal.

The CCPM module 115 can hide a logical relation between the vertical components processing switching signals such as the MGCP interface 151, the V5.2 interface 153 and the GR303 interface 155, and physical components such as PSTN and VoDSL ports, and physical configurations of the communication system such as switch configurations, and organize common and individual modules on the basis of call processing functions, thereby easily developing and verifying new voice service functions and reducing a period of time required to develop and stabilize the functions.

As apparent from the above description, the present invention provides horizontal components, which provide common functions and hence can be reused in various communication systems, thereby enabling a software module to be configured without depending upon an OS (Operating System) or hardware device, when a communication system is implemented.

Further, the present invention provides a CPM API capable of minimizing an additional workload according to program change at the time of call processing by hiding specific information associated with lower-order software and hardware according to respective interface modules.

Furthermore, the present invention provides a CCPM module capable of hiding a logical relation between the vertical components processing switch signals such as an MGCP interface, a V5.2 interface and a GR303 interface, and physical components such as PSTN and VoDSL ports, and physical configurations of the communication system such as switch configurations, and organizing common and individual modules on the basis of call processing functions, thereby easily developing and verifying new voice service functions and reducing a period of time required to develop and stabilize the functions.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

What is claimed is:

1. A method for performing common call processing management using a common software platform including horizontal components for providing common functions required in all communication systems, and vertical components for providing specific functions on the basis of communication systems, comprising the steps of:
allowing a common agent to perform corresponding operations including an operation of gathering Internet information on the basis of a predetermined schedule irrespective of a manager's intervention;
allowing an operations administration and maintenance module to administer and maintain a network in which the corresponding operations are performed on the Internet; and
allowing a common call processor to manage a subscriber in response to a call signal provided from a physical component receiving a subscriber signal and set up a voice path on the basis of the call signal where the subscriber signal can be transmitted through the voice path.

2. The method as set forth in claim 1, wherein the common call processor comprises:
a call processing management application program interface for providing a switching interface, subscriber interfaces and an interface between call processing modules;
an event decoding module for decoding a corresponding command and extracting physical termination information and a relation index;
a component specific call processing module for organizing components for performing corresponding functions based on the switching interface and the subscriber interfaces and interfacing with a lower-order module;
a common call signal management module for processing and routing a signal generated from the switching interface and a control signal to a corresponding module in response to a request from a subscriber interface;
a common connection management module for controlling a connection for setting up a voice path irrespective of hardware and an application program; and
a call resource management module for managing system resources associated with call processing.

3. The method as set forth in claim 2, wherein the component specific call processing module comprises a vertical component having at least one of a media gateway control protocol interface, a V5.2 interface and a GR303 interface being voice call signal interfaces.

4. The method as set forth in claim 3, wherein the physical component comprises at least one of a switch module, a tone generator and a physical port.

5. The method as set forth in claim 4, wherein the common call processor performs specific call processing according to kinds of vertical and physical components on the basis of the extracted physical termination information and relation index, allocates a system's switching resources, decides path information and generates a control command for a physical switch.

6. The method as set forth in claim 5, wherein the path information decided by the common call processor comprises address information associated with at least one of a card location and a destination by switching.

7. An apparatus for performing common call processing management using a common software platform including horizontal components for providing common functions required in all communication systems, and vertical components for providing specific functions on the basis of communication systems, comprising:
a common agent for performing corresponding operations including an operation of gathering Internet information on the basis of a predetermined schedule irrespective of a manager's intervention;
an operations administration and maintenance module for administering and maintaining a network in which the corresponding operations are performed on the Internet; and
a common call processor for managing a subscriber in response to a call signal provided from a physical component receiving a subscriber signal and setting up a voice path on the basis of the call signal such that the subscriber signal can be transmitted through the voice path.

8. The apparatus as set forth in claim 7, wherein the common call processor comprises:
a call processing management application program interface for providing a switching interface, subscriber interfaces and an interface between call processing modules;
an event decoding module for decoding a corresponding command and extracting physical termination information and a relation index;
a component specific call processing module for organizing components for performing corresponding functions based on the switching interface and the subscriber interfaces and interfacing with a lower-order module;
a common call signal management module for processing and routing a signal generated from the switching interface and a control signal to a corresponding module in response to a request from a subscriber interface;
a common connection management module for controlling a connection for setting up a voice path irrespective of hardware and an application program; and
a call resource management module for managing system resources associated with call processing.

9. The apparatus as set forth in claim 8, wherein the component specific call processing module comprises a vertical component having at least one of an media gateway control protocol interface, a V5.2 interface and a GR303 interface being voice call signal interfaces.

10. The apparatus as set forth in claim 9, wherein the physical component comprises at least one of a switch module, a tone generator and a physical port.

11. The apparatus as set forth in claim 10, wherein the common call processor performs specific call processing according to kinds of vertical and physical components on the basis of the extracted physical termination information and relation index, allocates a system's switching resources, decides path information and generates a control command for a physical switch.

12. The apparatus as set forth in claim 11, wherein the path information decided by the common call processor comprises address information associated with at least one of a card location and a destination by switching.
